(19) United States
(12) Patent Application Publication
(10) Pub. No.: US 2014/0172242 A1
(43) Pub. Date: Jun. 19, 2014

(54) VEHICLE SEAT DRIVE SYSTEM WITH NETWORK CONNECTIVITY

(71) Applicants: Dornier Technologie GmbH & Co., Uhldingen-Muhlhofen (DE); Bühler Motor GmbH, Nurnberg (DE)

(72) Inventors: Bernd Frühwald, Markt Erlbach (DE); Wolfgang Wagner, Friedrichshafen (DE); Stefan Grollich, Uhldingen-Muhlhofen (DE)

(73) Assignees: Dornier Technologie GmbH & Co., Uhldingen-Muhlhofen (DE); Bühler Motor GmbH, Nurnberg (DE)

(21) Appl. No.: 14/095,548

(22) Filed: Dec. 3, 2013

(30) Foreign Application Priority Data
Dec. 15, 2012 (DE) 102012024641.2

(51) Int. Cl. B60N 2/44

(52) U.S. Cl. CPC B60N 2/44
USPC 701/49

(57) ABSTRACT

A vehicle seat drive system, in particular an airplane passenger seat drive system, not requiring special software. The systems will be adaptable to new conditions over the course of the life of the installation thereof. The systems is monitorable at any time, and is capable of automatically reporting the occurrence of system faults. To accomplish this a direct link to a network that can be connected to the internet is provided.

### BACKGROUND OF THE INVENTION

(1) Field of the Invention

The invention described here comprises a system primarily deployable for vehicle seats, especially airplane passenger seat drive systems. It describes an improvement relating to the communication of the seat drive system and its components with higher-level systems.

(2) Description of Related Art Including Information Disclosed Under 37 CFR 1.97 and 1.98

It has been known for some time that individual drive elements of vehicle seats are controlled by mechanical operation but may also be electrically operated for the various functions for movement of the individual seats. An example in this context is the sliding of a motor vehicle seat into a position predefined in each case by the individual drivers (memory function, introduced in 1984). However, applications for automatic sliding of several seats (such as found in airline seats) into a specified position are also known. An example to be cited in this context is U.S. Pat. No. 4,669,780 from 1987.

To render such electrically operated systems functional, the individual elements or components of each seat must be made up of sensors on the one hand, and, on the other, must be connected in a form to make it possible for the components or the seats to communicate with one another. For that purpose, positions, running directions and running velocities are communicated from one drive element to another, for example. This was initially accomplished discretely and later generally on the basis of data buses. In this context the CAN data bus, which was developed for vehicles, is particularly noteworthy. It was developed by Bosch in 1983, and jointly introduced with Intel in 1987. From the 1990s on, the CAN bus was the standard for the automobile industry. Other industries soon followed, such as for example aviation.

When using such buses, controlling the individual system elements is straightforwardly possible, since in general a component group in the system adopts the “master” role and sends corresponding control signals via the bus. All aspects of the electrically operated movement of the various components constituting the seat can be communicated in this manner. This applies to dependent movements of the elements among each other, as well as also to the movement in relation to the surrounding structures.

Furthermore, it is known that systems of the type previously described have interfaces to parallel or higher-level systems. This is the case with, for example, airplane passenger seats. Here the seat drive system is generally connected to the entertainment system. The digital interfaces used in this context correspond, for example, to the RS 485 standard. This type of connection requires special software on both sides of the communication. This requirement frequently turns out to be disadvantageous because the implementation of this, frequently third-party, software is not always simple, and therefore considerably complicates certification.

### BRIEF SUMMARY OF THE INVENTION

The aim of the invention is to expand the capabilities that are described in the prior art. The purpose to be achieved on the one hand is that the systems will be adaptable to new conditions over the course of the life of the installation thereof. On the other hand, the systems should be monitorable at any time, and should even be capable of automatically reporting the occurrence of system faults.

This aim is achieved according to the invention by the provision in the seat drive system of a direct link to a network through a network connection that can be connected to the internet. By linking directly to a network that can be connected to the internet, the capability exists to call up information from an individual seat, or to transmit information to this seat. In the process, an existing open network that extends beyond the system is used in an effective and economical manner for different functions. This is achieved through the use of highly integrated components.

The invention provides that a communication channel is offered that is directly integrated into an intranet of the vehicle. Full access via the local system network is achieved via this connection, for example in the form of a WEB server, without affecting third-party systems in the process.

All of the components of a system, such as for example the elements of a high quality airplane passenger seat, can be addressed (actuated) in this manner. Wear, or fault situations can also be called up or are transmitted, in addition to the normal operating conditions and run times. On the basis of this information, the maintenance periods of systems can be designed in a variable manner. In the event of faults, adequate replacement parts can be provided in advance. This protects against outages of the overall system, which improves customer satisfaction and leads to cost savings.

Another aspect of this supplementary networking is, for example, the pre-setting of the system for new use. In the case of an airplane passenger seat, the seat configurations can thereby be set in advance for the expected passenger, for example. The seat configuration that was rated as comfortable most recently by the passenger could be established again, for instance. This could involve the seat firmness, the movement limits of the seat, the configuration of the lumbar support system, or also the color of the lights in the vicinity of the seat. Moreover, the seat can be personalized for each passenger through external interventions.

For example, the name may appear and information may be provided individually regarding flight progression, but also data regarding connecting flights or information regarding the baggage.

This pre-setting, as well as the information that is of interest to the passenger, can also be provided via corresponding connections through smart phones and/or tablet PCs. After the corresponding connection is established between the seat and the corresponding passenger unit via the system, controlling the seat can, also, take place via this passenger system. An app is offered to the passenger for this purpose.

### BRIEF DESCRIPTION OF THE DRAWING

An embodiment of the invention is explained in more detail in what follows, with reference to the drawing, in which:

FIG. 1 shows a block circuit diagram of the seat drive system in the vehicle.

### DETAILED DESCRIPTION OF THE INVENTION

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

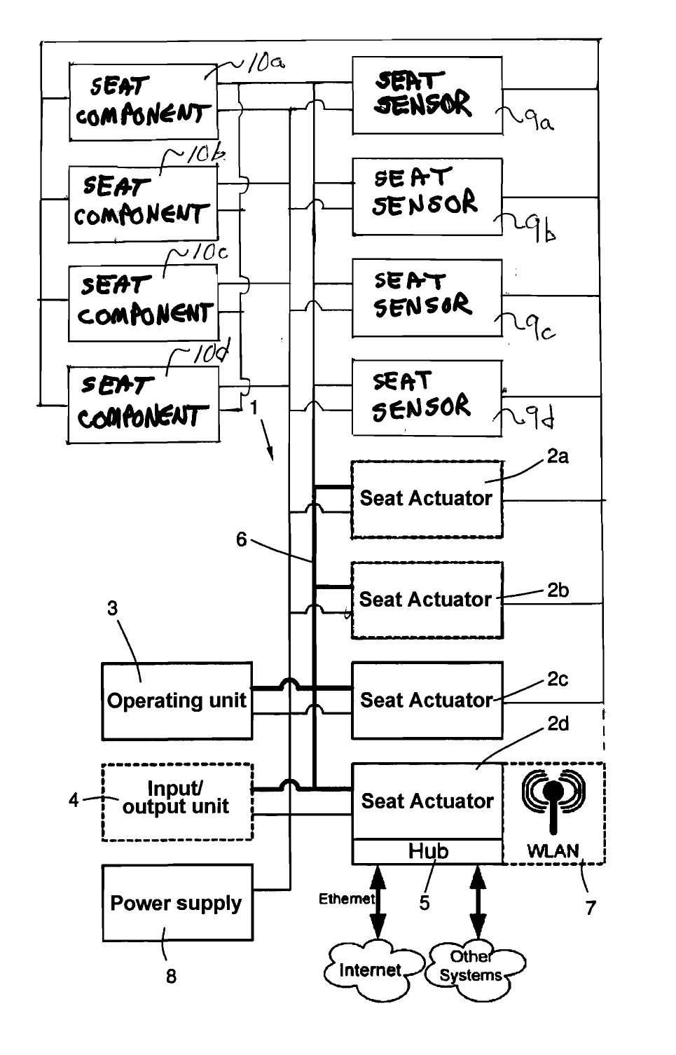

In FIG. 1 a block circuit diagram of a part of a seat drive system 1 is displayed. In the case of a single seat, a plurality of seat actuators 2a, 2b, 2c, and 2d is provided. Each actuator is associated with a particular seat component (10a, 10b, 10c, or 10d) and controls or drives that component. Among the seat components that are each driven by one of the actuators are a backrest, a headrest, a footrest, a leg support or a lumbar support system, etc. Each seat actuator is connected to a BUS 6. Each of the seat components is also associated with a seat sensor 9a, 9b, 9c, and 9d to detect the operation of the associated component. Each seat component 10 is also connected to the BUS 6. In addition to the seat actuators, an operating unit 3 for controlling operation of the seats and for receiving the outputs of the various seat sensors and at least one input/output unit 4 are connected to the BUS 6. Furthermore, all of the seat actuators 2a, 2b, 2c, 2d, the seat sensors 9a, 9b, 9c, and 9d, the operating unit 3 and the input/output unit 4 are connected to a power supply 8 of the vehicle. For reasons of clarity only some functions are displayed. One of the components, in this case the seat actuator 2d, is equipped with a hub 5, via which additional network users can be connected; this can be a smart phone or a tablet PC. The part of the seat drive system 1 is connected wirelessly to an on-board network via a wireless local area network (WLAN) interface 7. The on-board network has an Internet connection that can be established, in terms of radio technology, via satellite or directly via a ground-based station. An advantage of the displayed example is the variability regarding subsequent expansion, adaptation or other modification.

It is to be understood that the present invention is not limited to the illustrated embodiments described herein. Various types and styles of user interfaces may be used in accordance with the present invention without limitation. Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

### LIST OF REFERENCE NUMERALS

1 Seat drive system
2a Seat actuator for a backrest
2b Seat actuator for a leg support
2c Seat actuator for a footrest
2d Seat actuator for seat height
3 Operating unit
4 Input/output unit
5 Hub
6 BUS
7 WLAN interface
8 Power supply
9a Seat sensor for a backrest
9b Seat sensor for a leg support
9c Seat sensor for a footrest
9d Seat sensor for a seat height
10 Seat Components (Includes backrest, leg support, footrest, and seat height)

What is claimed is:

1. A vehicle seat drive system connectable to the Internet, the vehicle seat drive system comprising:
a local area network (LAN);
means for connecting the LAN to the Internet;
a plurality of adjustable seats, each of said seats including a plurality of adjustable components;
a plurality of seat actuators, each of said actuators associated with a particular component of one of said adjustable seats, the plurality of seat actuators being directly operatively connected to the LAN;
a plurality of seat sensors, each of said sensors associated with a particular component of one of said adjustable seats, the plurality of seat sensors being directly operatively connected to the LAN; and
a operating unit for receiving signals from the plurality of seat sensors, for operating the plurality of seat actuators, and for controlling the interface of the seat actuators and the seat sensors with the LAN.

2. The vehicle seat drive system according to claim 1, further comprises a WEB server and thereby is directly addressable via the Internet or the LAN.

3. The vehicle seat drive system according to claim 1, further comprising means to transmit messages automatically via the LAN, which messages can be received and processed by a higher-level unit.

4. The vehicle seat drive system according to claim 3, wherein the higher level unit is a maintenance system.

5. The vehicle seat drive system according to claim 1 further comprising means for operating the operating unit be external to the vehicle, and the seats can thereby be parameterized or also personalized.

6. The system according to claim 1, further comprising an integrated hub for connecting additional network users.

7. The vehicle seat drive system according to claim 1, further comprising an app for providing a user a means for controlling the seat from a smart device.
